(19) United States
(12) Patent Application Publication
(10) Pub. No.: US 2026/0103903 A1
(43) Pub. Date: Apr. 16, 2026

(54) TROWEL ASSEMBLY

(71) Applicant: TMK Designs, LLC, San Diego, CA (US)

(72) Inventor: Lawrence C. NORA, San Diego, CA (US)

(21) Appl. No.: 18/916,973

(22) Filed: Oct. 16, 2024

(51) Int. Cl. E04F 21/24; H01M 10/0525; H01M 50/202; H01M 50/247; H01M 50/262

(52) U.S. Cl. CPC E04F 21/248; H01M 10/0525; H01M 50/202; H01M 50/247; H01M 50/262; H01M 2220/30

(57) ABSTRACT

A trowel assembly for finishing a surface includes a housing that defines a compartment. A rod is coupled with the housing and extends away from the housing for being handled by a user to control the trowel assembly. A rotor is rotatably coupled to the housing. A plurality of blade assemblies are coupled to the rotor and arranged in circumferentially spaced relationship with one another for compacting and flattening the wall during rotation of the blade assemblies. An electric motor is positioned in the housing and includes an output coupled to the blade assemblies for providing the rotational movement of the blade assemblies.

### FIELD OF THE INVENTION

The present disclosure relates to a trowel assembly for flattening and finishing a ground surface.

### BACKGROUND

Rotary powered trowel assemblies are known for flattening and finishing ground surfaces, such as freshly poured concrete. Rotary trowel assemblies typically utilize an arrangement of rotating blades which are supported by a housing and driven by a gas motor. An elongated rod and handle are connected to the housing to permit an operator to control the trowel assembly. During use, the blades are configured to brush the surface, to create a flat and uniform surface, and to remove excess water from the surface.

Existing rotary powered trowel assemblies face challenges related to maneuverability, weight distribution, and operator control, particularly on uneven surfaces or in confined spaces. Additionally, there are concerns regarding operator fatigue due to prolonged use. Accordingly, there remains a need for improvements to rotary powered trowel assemblies.

### SUMMARY OF THE INVENTION

According to an aspect of the disclosure, a trowel assembly for finishing a surface includes a housing that defines a compartment. A rod is coupled with the housing and extends away from the housing for being handled by a user to control the trowel assembly. A rotor is rotatably coupled to the housing. A plurality of blade assemblies are coupled to the rotor and arranged in circumferentially spaced relationship with one another for compacting and flattening the wall during rotation of the blade assemblies. An electric motor is positioned in the housing and includes an output coupled to the blade assemblies for providing the rotational movement of the blade assemblies.

Because of the use of an electric motor, the subject trowel assembly is lightweight and easy to handle. This provides a decrease in operator fatigue and improved quality. Furthermore, the trowel assembly operates at low noise level, up to about 25% less noise dBA than gas powered trowel assemblies. Additionally, the electric motor produces zero emissions, which allows the trowel assembly to be used on concrete poured indoors without having to contend with carbon monoxide emissions.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a top perspective view of a trowel assembly according to an aspect of the present disclosure;

FIG. 2 is a bottom view of a lower shell of a housing of the trowel assembly;

FIG. 3 is a front, perspective view of the housing;

FIG. 4 is a rear, perspective view of the housing;

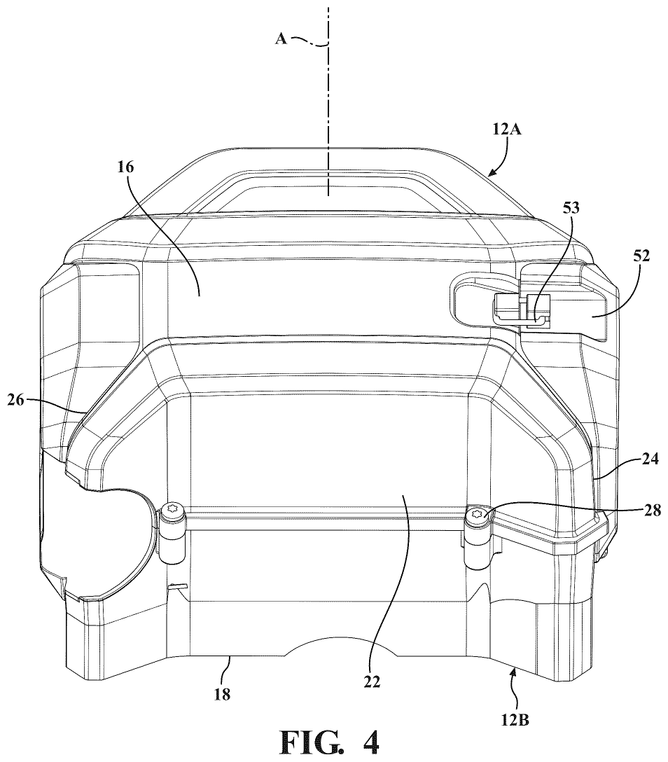

FIG. 5 is a left, perspective view of the housing;

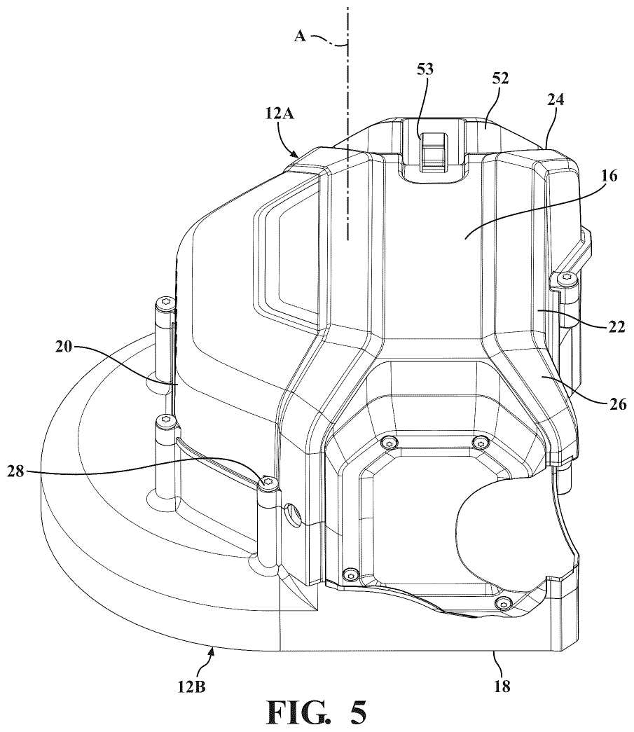

FIG. 6 is a top view of the lower shell of the housing with the upper shell and associated battery and control modules removed;

FIG. 7 is a top view of the lower shell of the housing with the upper shell removed, and illustrating a battery, electric motor and control module positioned in the housing;

FIG. 8 is a right, perspective side view of the trowel assembly;

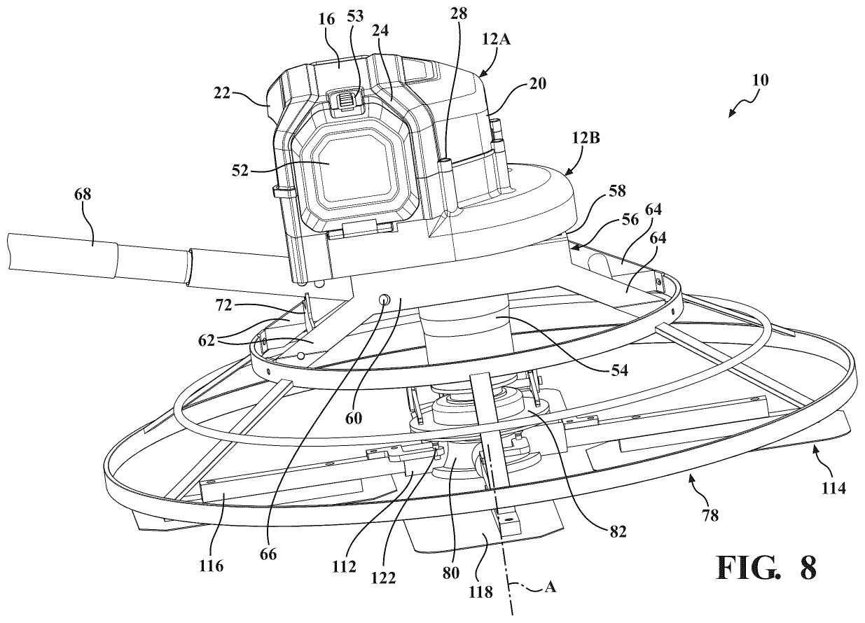

FIG. 9 is a perspective bottom view of the trowel assembly;

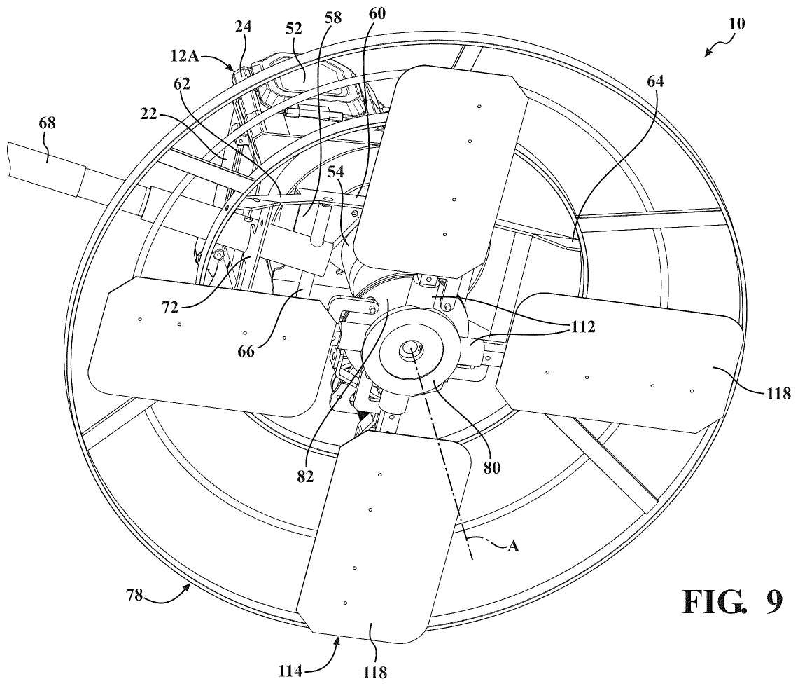

FIG. 10 is perspective, top view of the trowel assembly;

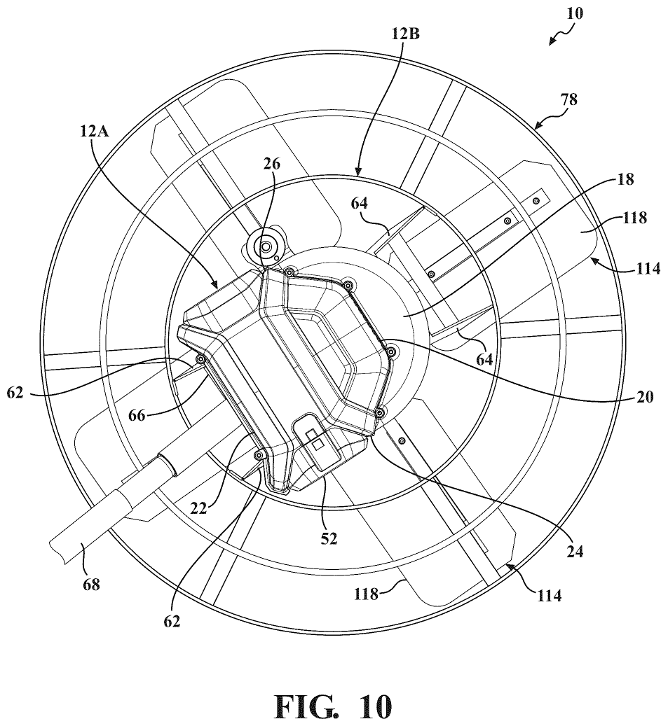

FIG. 11 is a left, perspective side view of the trowel assembly; and

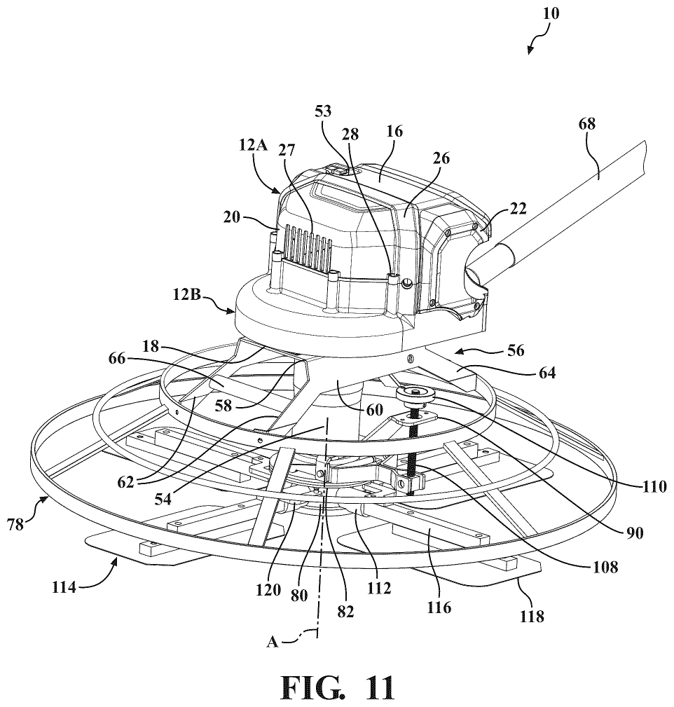

FIG. 12 is a magnified, perspective view of the trowel assembly.

### DESCRIPTION OF THE ENABLING EMBODIMENT

Referring to the figures, wherein like numerals indicate corresponding parts throughout the several views, a trowel assembly 10 for finishing a surface, such as freshly poured concrete, is provided. The trowel assembly 10 may be used to finish various types of surfaces.

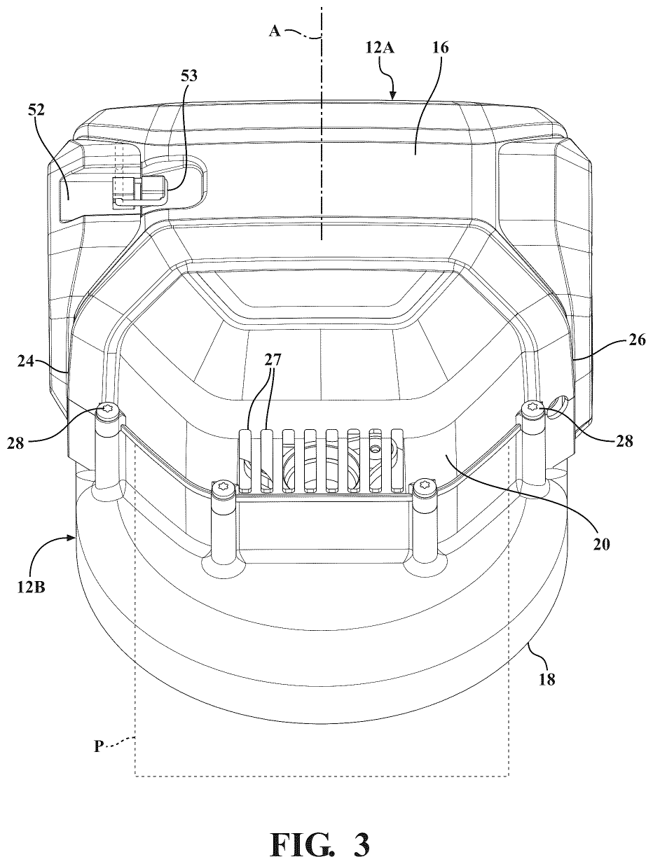

The trowel assembly 10 includes a housing 12A, 12B that defines a compartment 14. The housing 12A, 12B has a top wall 16, a bottom wall 18, a front wall 20, a rear wall 22, a first side wall 24 and as second side wall 26. The front wall 20 defines a plurality of vent holes 27 for venting heated air from the compartment 14. The housing 12A, 12B has an upper shell 12A and a lower shell 12B that are connectable to one another along a horizontal plane P (shown in FIG. 3). A plurality of fasteners 28, such as bolts, connect the upper shell 12A to the lower shell 12B.

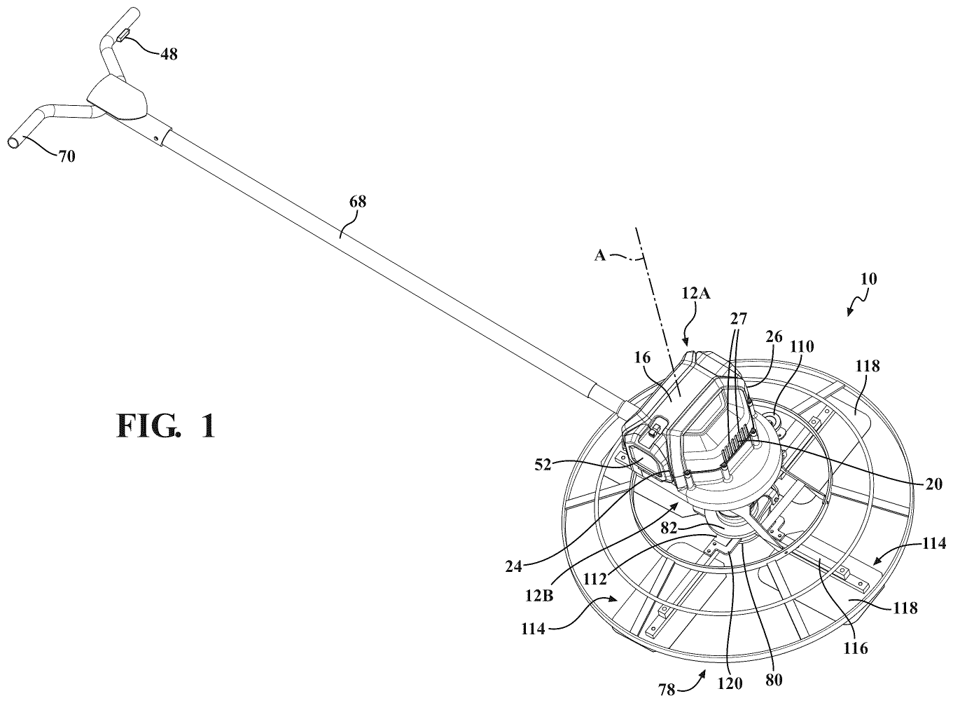

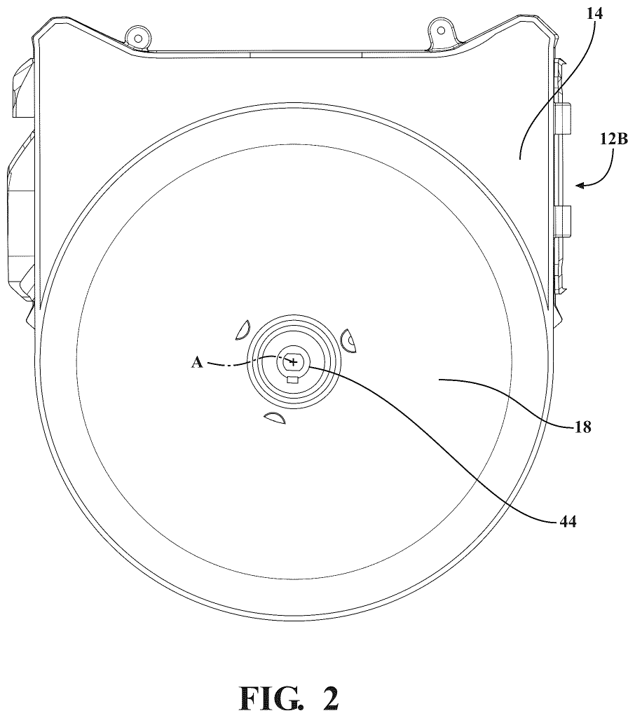

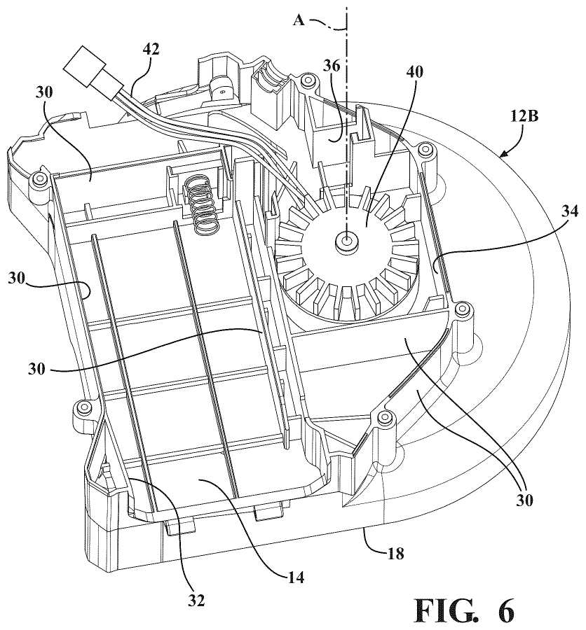

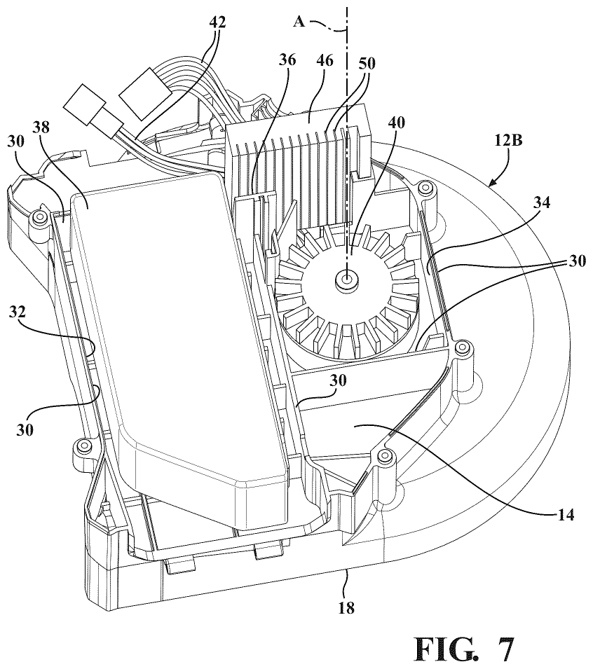

As best shown in FIG. 6, a top face of the bottom wall 18 presents a plurality of interior walls 30 that extend upwardly from the bottom wall 18 and define a battery segment 32, a motor segment 34 and a controller segment 36. As best shown in FIG. 7, a battery 38 is removeably positioned in the battery segment 32. According to embodiments, a 36 volt a lithium ion battery is used, but other types of batteries may be used without departing from the scope of the present disclosure. An electric motor 40 is positioned in the motor segment 34. As best shown in FIG. 2, the electric motor 40 has an output 44 that extends through the lower shell 12B of the housing 12A, 12B along an axis. With reference back to FIG. 6, a control module 46 is positioned in the controller segment 36 adjacent to the electric motor 40 for adjusting a speed of the output 44 of the motor 40. The control module 46, electric motor 40 and battery 38 are electrically connected to one another via an arrangement of wires 42. One or more inputs 48 (schematically shown in FIG. 1), such as buttons or a trigger, are connected to the control module 46 for allowing an operator to adjust the output 44 of the motor 40. The control module 46 defines a plurality of fins 50 for dissipating heat from the control module 46.

A flap 52 pivotally connected to the lower shell 12B of the housing 12A, 12B along the first side wall 24. The flap 52 is detachably connected to the upper shell 12A of the housing 12A, 12B along the first side wall 24 such that an operator may open the flap 52 to remove and replace the battery 38, and close the flap 52 to seal the compartment 14 prior to use. A tab 53 is moveably positioned at the top of the flap 52 for locking and unlocking the flap 53. FIG. 3 presents the tab 53 in a closed position in solid lines and in an open position in dashed lines.

A generally cylindrical-shaped gear case 54 extends axially away from the bottom wall 18 of the lower shell 12B. The gear case 54 has an input end that is coupled to the output 44 of the motor 40 for rotation with the output 44 of the motor 40, and a rotatable output end opposite the input end. A series of gears are located in the gear case 54 between the input end and the output end for providing a gear reduction between the input and the output ends.

A mounting assembly 56 is positioned beneath the lower shell 12B of the housing 12A, 12B about the gear case 54. The mounting assembly 56 has a plate 58 that underlies the bottom wall 18 of the lower shell 12B of the housing 12A, 12B. The mounting assembly 56 also has a pair of side flanges 60 that extend downwardly from the plate 58 on opposite sides of the plate 58 and extend in a longitudinal direction. A pair of rear legs 62 extend downwardly and longitudinally away from each of the side flanges 60. Similarly, a pair of front legs 64 extend downwardly and longitudinally away from each of the side flanges 60.

A pivot pin 66 extends between and is pivotally connected to the rear legs 62. A rod 68 is connected to the pivot pin 66 such that the rod 68 is pivotable relative to the rear legs 62. As best shown in FIG. 1, a handle 70 is connected to the rod 68 for permitting a user to control the trowel assembly 10. According to embodiments, the rod 68 is extendable to different lengths provide versatile use.

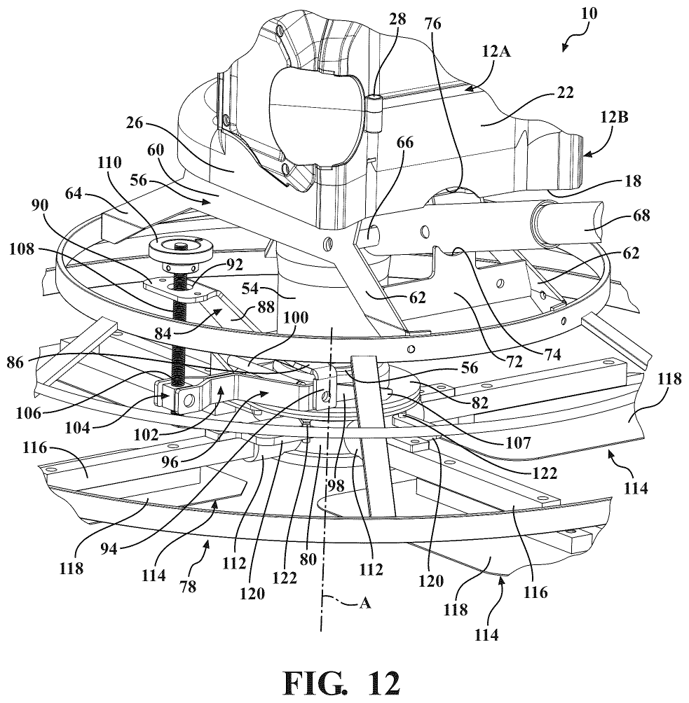

As best shown in FIG. 12, the mounting assembly 56 also includes a support 72 that extends between the rear legs 62 beneath the pivot pin 66. The support 72 defines an arc-shaped cutout 74 that is configured to limit downward pivoting movement of the rod 68. The bottom wall 18 of the lower shell 12B also defines an arc-shaped cutout 76 for limiting upward pivoting movement of the rod 68.

A shroud cage 78 is connected to the legs 62, 64 of the mounting assembly 56. The shroud cage 78 tapers radially outwardly as it extends axially away from the mounting assembly 56 such that an opening of the shroud cage 78 widens as it extends downwardly.

As best shown in FIG. 12, a rotor 80 is coupled to the output end of the gear case 54 and is configured to rotate with the output end of the gear case 54. A disc 82 is disposed annularly about the rotor 80. The disc 82 is axially moveable along the rotor 80.

A first lever 84 has a base 86 that is fixed to the rotor 80, and a tongue 88 that extends upwardly at an angle from the base 86, and terminates at a first threaded region 90 opposite the base 86. The first threaded region 90 defines a first threaded bore 92. A pair of arms 94 extend downwardly from the opposite sides of the base 86.

A second lever 96 is has a pair fingers 98 that extend in space and parallel relationship with one another. The fingers 98 are pivotally connected to the arms 94 of the first lever 84 along a second pivot pin 100. A coupling member 102 extends from the fingers 98 and terminates at a second threaded region 104. The second threaded region 104 defines a second bore 106. The fingers 98 each terminate at a pressing end 107 opposite the coupling member 104 such that the second pivot pin 100 is located between the pressing end 107 and the coupling member 104. The pressing ends 107 each engage the lower disc 82.

A threaded adjustment bolt 108 is threadedly received by the first and second threaded bores 92, 106. A dial 110 is connected to a top of the adjustment bolt 108 for permitting a user to rotate the adjustment bolt 108. Rotation of the dial 110 and the adjustment bolt 108 accordingly cause the coupling member 102 of the second lever 96 to pivot upwardly, thereby causing the pressing ends 107 of the fingers 98 to be pivoted about the pivot pin 100 downwardly against the disc 82 to cause the disc 82 to move axially downwardly.

A plurality of tubes 112 extend radially from the rotor 80 in circumferentially spaced relationship with one another. A plurality of blade assemblies 114 are coupled to the tube 112 inside the shroud cage 78 and arranged in circumferentially spaced relationship with one another for rotating with the rotor 80. More particularly, each of the blade assemblies 114 is comprised of a pivot bar 116 that is rotatably received in one of the tubes 112 of the rotor 80, and a blade 118 connected to a bottom of the pivot bar 116. The blades 118 are each planar and are longer than they are wide. The blades 118 are used to compact and flatten the surface during rotation of the blades 18.

Each of the blade assemblies 114 further has a pivot flange 120 positioned on top of the pivot bar 116. Each of the pivot flanges 120 has a first part that is positioned over the pivot bar 116 and a second part that is spaced from the pivot bar 116. A bolt 122 extends upwardly from each of the pivot flanges 120 in alignment with the disc 82. During use, rotation of the threaded bolt 108 with the dial 110 causes the pressing ends 107 of the fingers 98 of the second lever 96 to be raised or lowered against the disc 82. The disc 82 correspondingly engages the bolt 122 and causes the blades 118 to pivot relative to the tubes 112 to adjust an angle at which the blades 118 contact the ground. The blades 118 are pivotable between a floating position in which the blades 118 are slightly angled to create a uniform surface and remove excess water, helping to prepare the surface for the finishing phase. In a finishing position, the blades 118 are at a flatter angle, allowing for a smoother surface and the removal of imperfections.

Because of the use of an electric motor 40, the subject trowel assembly 10 is lightweight and easy to handle. This provides a decrease in operator fatigue and improved quality. Furthermore, the trowel assembly 10 operates at low noise level, up to about 25% less noise dBA than gas powered trowel assemblies. Additionally, the electric motor 40 produces zero emissions, which allows the trowel assembly 10 to be used on concrete poured indoors without having to contend with carbon monoxide emissions.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in that particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or later, or intervening element or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to described various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A trowel assembly for finishing a surface, comprising:
a housing defining a compartment;
a rod coupled with the housing and extending away from the housing for being handled by a user to control the trowel assembly;
a rotor rotatably coupled to the housing, and a plurality of blade assemblies coupled to the rotor and arranged in circumferentially spaced relationship with one another for compacting and flattening the surface during rotation of the blade assemblies; and
an electric motor positioned in the housing and including an output coupled to the blade assemblies for providing the rotational movement of the blade assemblies.

2. The trowel assembly as set forth in claim 1, further including a battery positioned in the housing and electrically connected to the electric motor for powering the electric motor.

3. The trowel assembly as set forth in claim 2, wherein the battery is a lithium ion battery.

4. The trowel assembly as set forth in claim 3, wherein the battery is a 36 volt lithium ion battery.

5. The trowel assembly as set forth in claim 1, wherein the battery is removably positioned in the compartment of the housing.

6. The trowel assembly as set forth in claim 5, where the housing includes a pivotable battery flap configured to open the housing to permit access to the battery.

7. The trowel assembly as set forth in claim 1, wherein a gear case interconnects the output of the motor and the rotor for providing a gear reduction between the output of the motor and the rotor.

8. The trowel assembly as set forth in claim 1, a control module positioned in the housing and electrically connected to the electric motor for controlling a speed at which the blade assemblies rotate.

9. The trowel assembly as set forth in claim 8, wherein the control module includes a plurality of fins for emitting heat away from the control module.

10. The trowel assembly as set forth in claim 9, wherein the housing includes a plurality of interior walls inside the compartment, wherein the interior walls separate the compartment into a motor segment, a battery segment and a control module segment, and wherein the electric motor is positioned in the motor compartment, the battery is positioned in the battery compartment, and the control module is positioned in the control module compartment.

11. The trowel assembly as set forth in claim 1, wherein the blade assemblies each include a blade being pivotable for adjusting an angle at which the blade contacts the surface.

12. The trowel assembly ass set forth in claim 11 further including a dial coupled to the blade assemblies for pivoting the blades in response to rotation of the dial.

13. The trowel assembly as set forth in claim 1, wherein the rod is pivotally connected to the housing for adjusting an angle at which an operator holds the rod relative to the housing.

14. The trowel assembly as set forth in claim 13, wherein the rod is connected to the housing beneath the electric motor and battery assembly.

15. The trowel assembly as set forth in claim 13, wherein a support limits downward pivoting movement of the rod, and wherein the housing limits upward pivoting movement of the rod.

16. The trowel assembly as set forth in claim 1, wherein a handle is coupled with the rod for permitting an operator to control the trowel assembly.

17. The trowel assembly as set forth in claim 16, wherein at least one input is located on the handle for permitting the operator to control the electric motor.

18. The trowel assembly as set forth in claim 1, wherein the housing defines a plurality of vent holes for venting heated air in the compartment of the housing.

19. The trowel assembly as set forth in claim 1, wherein the housing is comprised of an upper shell and a lower shell being releasably connected to one another.

20. The trowel assembly as set forth in claim 19, wherein the upper and lower shells are fixed to one another with a plurality of fasteners.
